(19) United States
(12) Patent Application Publication
(10) Pub. No.: US 2010/0264619 A1
(43) Pub. Date: Oct. 21, 2010

(54) Bicycle pedaling system

(76) Inventor: Ernesto Haynes, Laredo, TX (US)

Correspondence Address: LITMAN LAW OFFICES, LTD., PATENT LAW BUILDING, 8955 CENTER STREET, MANASSAS, VA, 20110, US

(21) Appl. No.: 12/662,497

(22) Filed: Apr. 20, 2010

Related U.S. Application Data
(60) Provisional application No. 61/202,938, filed on Apr. 21, 2009.

(51) Int. Cl. B62M 1/10; F16D 41/30; F16H 55/30

(52) U.S. Cl. 280/217; 192/64

(57) ABSTRACT

The bicycle pedaling system includes a weighted outer disc having a bicycle chain sprocket(s) mounted on one side, the outer disc having a central bore with a plurality of ratchet teeth projecting inwardly at an angle from the interior surface of the central bore. An inner disc is coaxially mounted in the central bore, the inner disc being journaled to bicycle pedals, the inner disc having at least one pawl projecting from its periphery to selectively engage the ratchet teeth. When pedaling, the pawl engages the ratchet teeth and propels the bicycle, and when pedaling is stopped, the outer disc freely rotates about the inner disc to thereby provide continuous momentum to ease subsequent resumption of pedaling effort.

### CROSS-REFERENCE TO RELATED APPLICATION

This application claims the benefit of U.S. Provisional Patent Application Ser. No. 61/202,938, filed Apr. 21, 2009.

### FIELD OF THE INVENTION

The present invention relates to bicycle chain drives, and more particularly to a bicycle pedaling system that reduces the pedaling effort required for traversing slopes.

### DESCRIPTION OF THE RELATED ART

The advent of bicycles has increased personal mobility around the world. The activity provides great health benefits and a positive environmental impact from bicycling commuters since no harmful polluting gases are produced from the activity. While bicycles provide many positive benefits, at times, it still requires great physical effort in traversing certain terrains such as slopes.

Current bicycles include a multi-sprocket gearing system that allows a user to select a relatively ideal gear for traversing a given terrain depending on how much physical effort the user is willing to put forth. However, this type of system does not fully maximize the physical energy provided by the user. Another type of bicycle crank system utilizes a relatively complex array of chains and sprockets for a flywheel design, which adds considerable weight to the bicycle and may be a daunting prospect for some users. Thus, it would be beneficial in the art to provide a bicycle crank system that reduces pedaling effort required to traverse difficult terrain.

Thus, a bicycle pedaling system solving the aforementioned problems is desired.

### SUMMARY OF THE INVENTION

The bicycle pedaling system includes a drive sprocket wheel that has a weighted outer disc having at least one bicycle chain sprocket mounted on one side, the outer disc having a stepped central bore with a plurality of ratchet teeth projecting inwardly at an angle from the interior surface of the central bore. The stepped portion of the central bore defines at least one race for ball bearings. A stepped inner disc is coaxially mounted in the central bore, the inner disc being journaled to bicycle pedals. The inner disc has a first outer diameter and surface and a second outer diameter and surface, the second outer diameter of the inner disc being larger than the first outer diameter of the inner disc. At least one pawl projects outwardly at an angle from the first outer surface of the inner disc. The pawl is one-way engageable with the ratchet teeth of the outer disc so that when pedaling, the pawl arm engages the ratchet teeth and propels the bicycle, and when pedaling is stopped, the outer disc freely rotates about the inner disc to thereby provide continuous momentum to ease subsequent resumption of pedaling effort.

These and other features of the present invention will become readily apparent upon further review of the following specification and drawings.

### BRIEF DESCRIPTION OF THE DRAWINGS

FIG. 1 is a perspective view of a bicycle pedaling system according to the present invention.

FIG. 2 is an exploded perspective view of the bicycle pedaling system of FIG. 1.

FIG. 3 is a side view of the bicycle pedaling system of FIG. 1, showing the chain sprocket mounting side of the sprocket drive wheel.

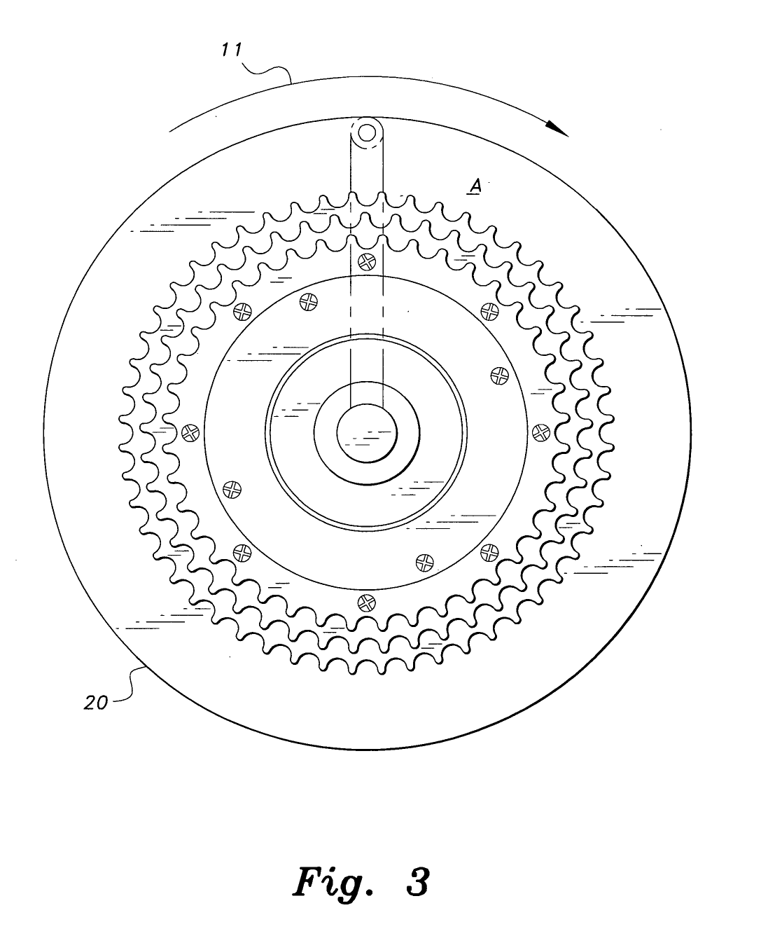

FIG. 4 is a side view of the bicycle pedaling system of FIG. 3, showing the opposite side of the sprocket drive wheel from FIG. 3.

FIG. 5 is a section view of a bicycle chain drive wheel, showing details of the bicycle pedaling system of FIGS. 1-4.

FIG. 6 is an environmental side view of a bicycle pedaling system according to the present invention, shown with an optional momentum booster on the rear wheel of the bicycle.

FIG. 7 is a side view of the momentum booster of FIG. 6, showing the wheel from the opposite side as FIG. 6 and without the tire, and showing optional weights attached to the momentum booster.

FIG. 8 is a section view of the wheel assembly of FIG. 6, showing details of the momentum booster.

FIG. 9 is an environmental side view of a bicycle pedaling system according to the present invention, shown with an alternative embodiment of the momentum booster on the rear wheel of the bicycle.

Similar reference characters denote corresponding features consistently throughout the attached drawings.

### DETAILED DESCRIPTION OF THE PREFERRED EMBODIMENTS

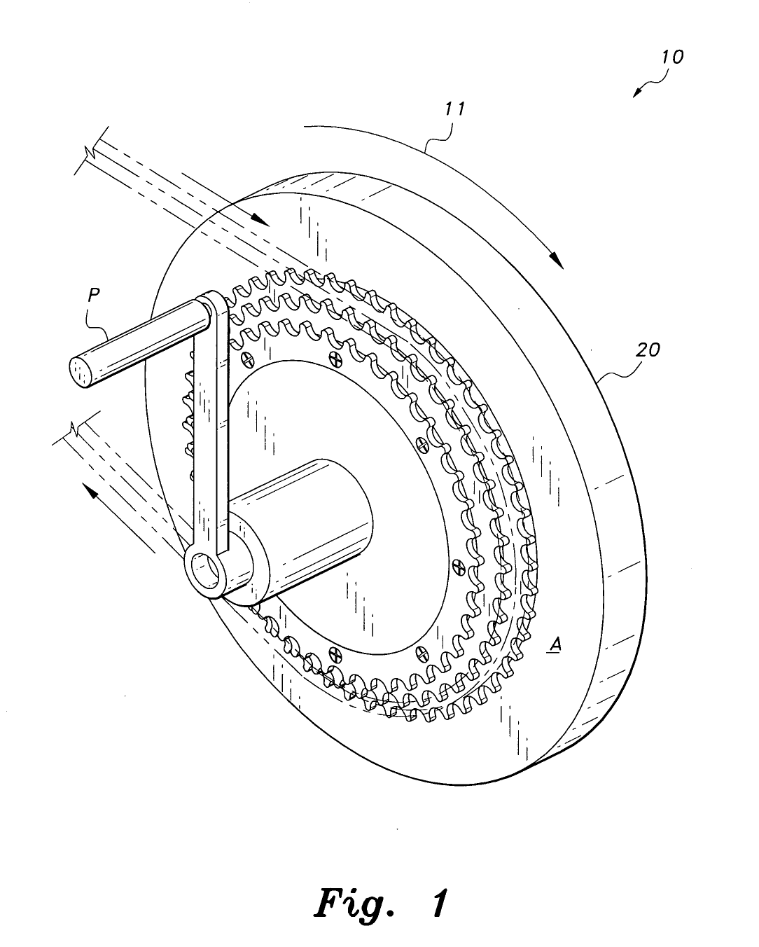

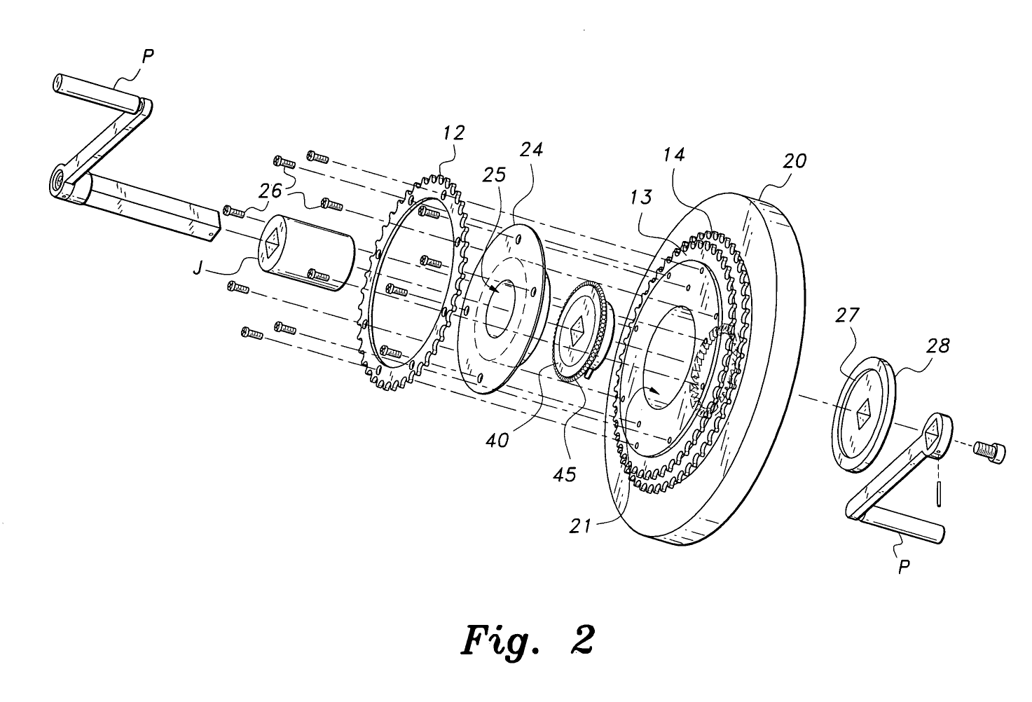

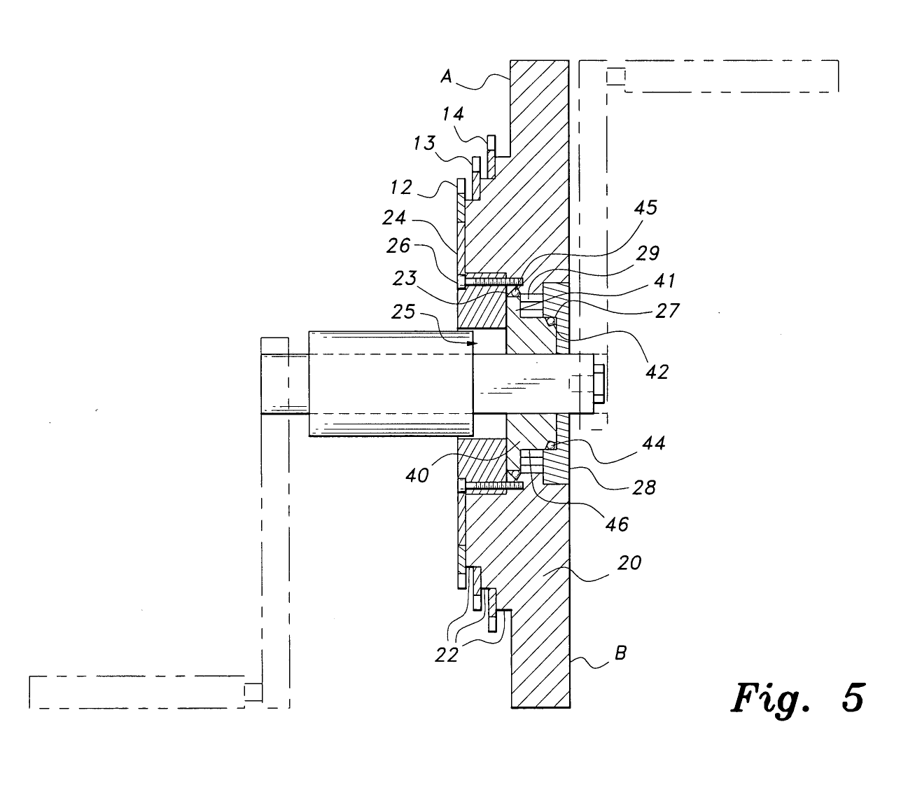

The present invention relates to a bicycle pedaling system that maximizes generated momentum to ease traversal of slopes or other physically demanding terrain. Bicycle chain drives include a sprocket drive wheel mounted to the bicycle frame, the drive wheel having pedals to crank the drive wheel, the chain drive having a rear driven sprocket wheel coupled to the rear wheel of the bicycle. Referring to FIGS. 1, 2 and 5, the bicycle pedaling system 10 includes a sprocket drive wheel that has a weighted circular outer disc 20 and a circular inner disc 40 coaxially mounted within the outer disc 20. The outer disc 20 includes first and second sides A, B and a stepped central bore 21 (a bore having a series of shoulders defining ledges of progressively smaller diameter), through which the inner disc 20 and the pedals P may be mounted.

The first side A of the outer disc 20 includes an axially projecting, externally stepped axle 22. The stepped portions of the axle 22 define mounting seats or shoulders for one or more bicycle chain sprockets 12, 13, 14 that are attached to the outer disc 20 by fasteners 26. Each sprocket 12, 13, 14 has a different diameter, and each stepped portion of the axle 22 accommodates a corresponding diameter sprocket. The sprockets 12, 13, 14 receive a chain that also extends over the rear or driven sprocket(s) on a bicycle B.

A first cap 24 having a central bore 25 covers the distal end of the axle 22. The first cap 24 may be secured to the axle 22 by fasteners 26. The other or second side B of the outer disc 20 also includes a second cap 28 that covers the second side B when all the parts are assembled.

The inner disc 40 is substantially T-shaped in cross section and includes a circular flanged portion 41 radially projecting from one axial end of the smaller diameter main body portion 46 of the inner disc 40. Thus, the outer edge of the circular flanged portion 41 has a first diameter, and the main body 46 has a second diameter, the first diameter being larger than the second diameter. The outer surface of the flanged portion 41, together with an inner, annular groove 23 within the bore 21 of the outer disc 20, defines a race for ball bearings 45. The opposite axial end of the main body portion 46 includes an annular groove 42, which, together with an inner surface 27 of the second cap 28, defines a second race for another set of ball bearings 44. The sets of ball bearings 44, 45 allow smooth rotation of the outer and inner discs 20, 40 relative to each other. Pedals P have a square spindle and are operatively mounted to the inner disc 40 through a journal j journal or adapter that may be keyed to the bore 25 in the first cap 24, and then through the bores in the inner disc 40 and the second cap 28.

The bicycle pedaling system 10 facilitates decreased physical effort to traverse adverse terrain, e.g., slopes, by maximizing user-generated momentum from pedaling. To that end, the bicycle pedaling system 10 includes features that selectively drive the outer disc 20 when pedaling, but permit the outer disc 20 to freely rotate when pedaling is stopped. Due to the weight of the outer disc 20, the rotation of the outer disc 20 produces additional rotational momentum from inertia or a flywheel effect that continues even with the pedals P are not being used to crank the drive sprocket so that subsequent pedaling will not require as much torque or effort to overcome the terrain obstacle.

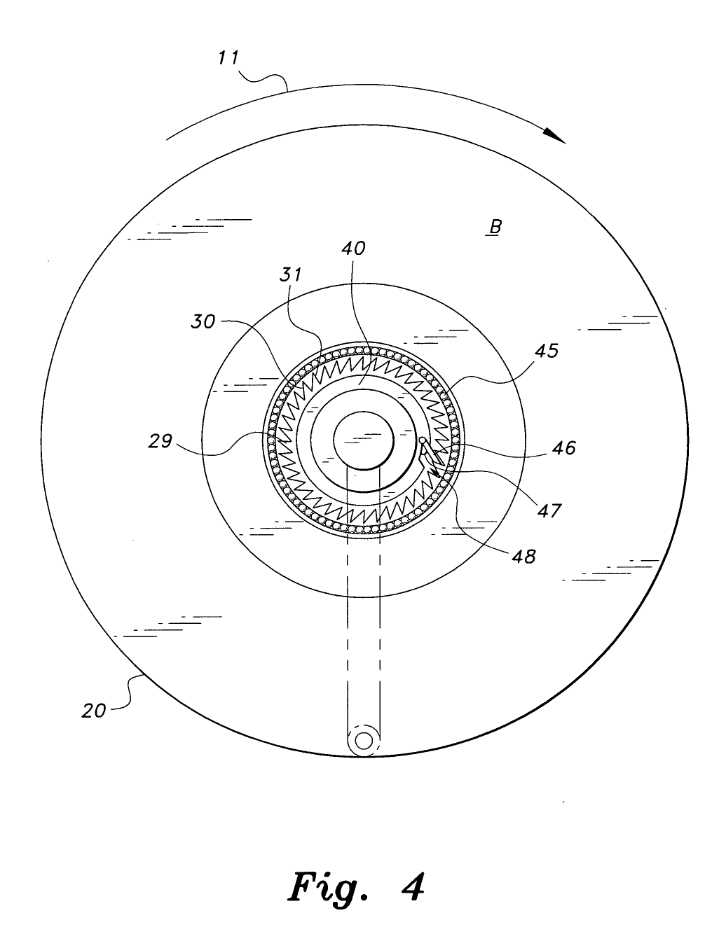

To selectively drive the outer disc 20, reference is made to FIG. 4. The bicycle pedaling system 10 includes a ratchet system between the two discs 20, 40. The outer disc 20 includes a plurality of integrally formed ratchet teeth 29 radially inward in the outer disc 21. The ratchet teeth 29 project inwardly, at an angle towards the center of the bore 21, and each tooth 29 includes a front catch surface 31 and a rear, non-catch, sloping surface 30. The inner disc 40 includes at least one axially extending notch, recess or pocket 48 formed intermediate the two axial ends of the inner disc 40. The pocket 48 seats a pivotally mounted pawl 46 that extends at an angle counter to the angular orientation of the ratchet teeth 29. The pawl 46 is normally biased in the above position by a spring 47. Thus, whenever the inner disc 40 is rotated in the direction indicated by arrow 11 by user input on the pedals P, the pawl 46 engages the front surface 31 of one of the ratchet teeth 29 to drive the outer disc 20. When pedaling is stopped, the outer disc 40 continues to rotate due to inertia, the ratchet pawl 46 being pivoted downward by the rear surface 30 of successive teeth 29.

In some instances, momentum generated from the outer disc 20 may not be sustainable or sufficient to overcome some of the terrestrial irregularities or undulations in the path of travel. To help maintain the generated momentum, the bicycle pedaling system 10 optionally includes a momentum booster 50 forming the rear wheel of a bicycle B.

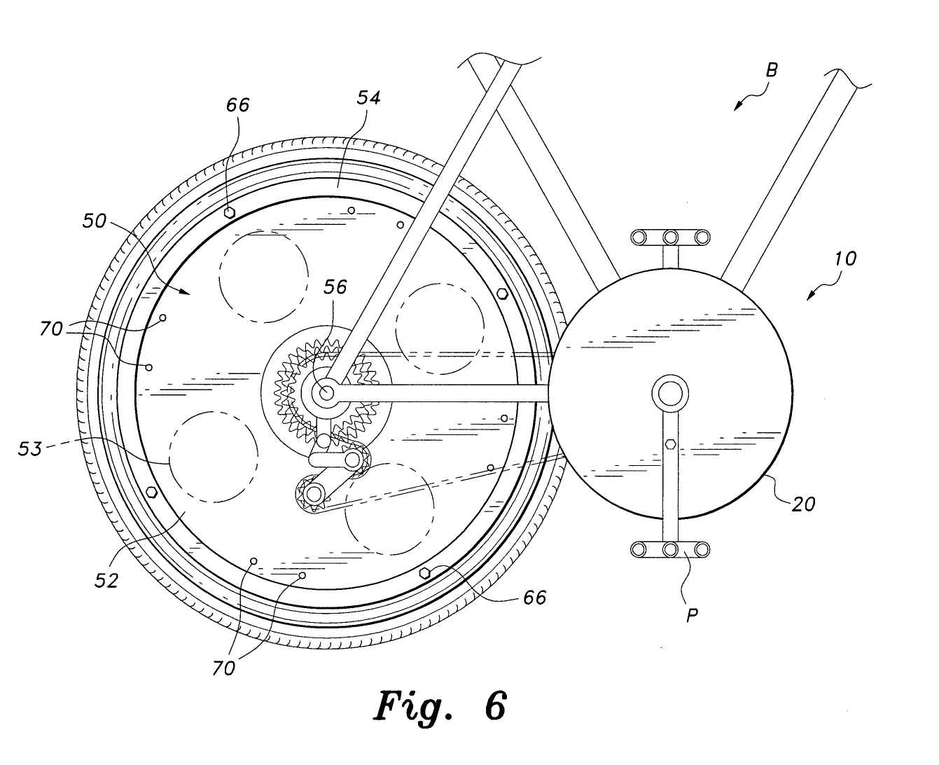

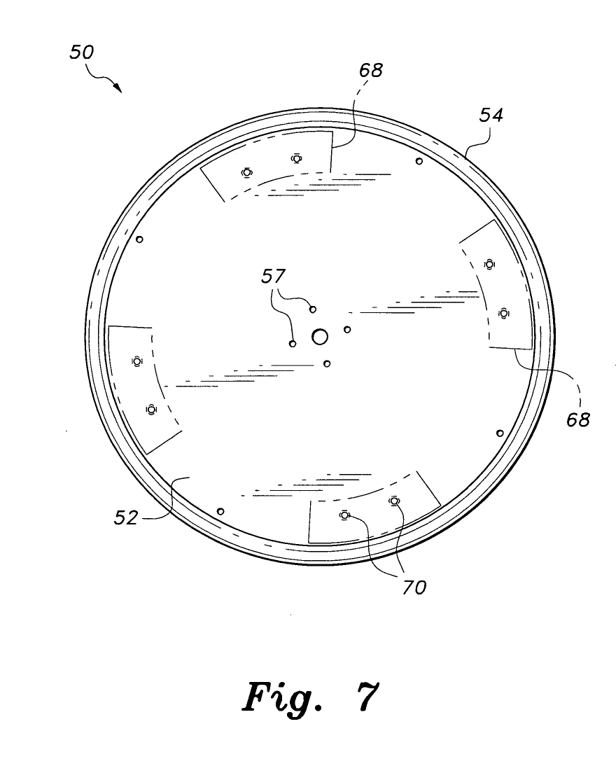

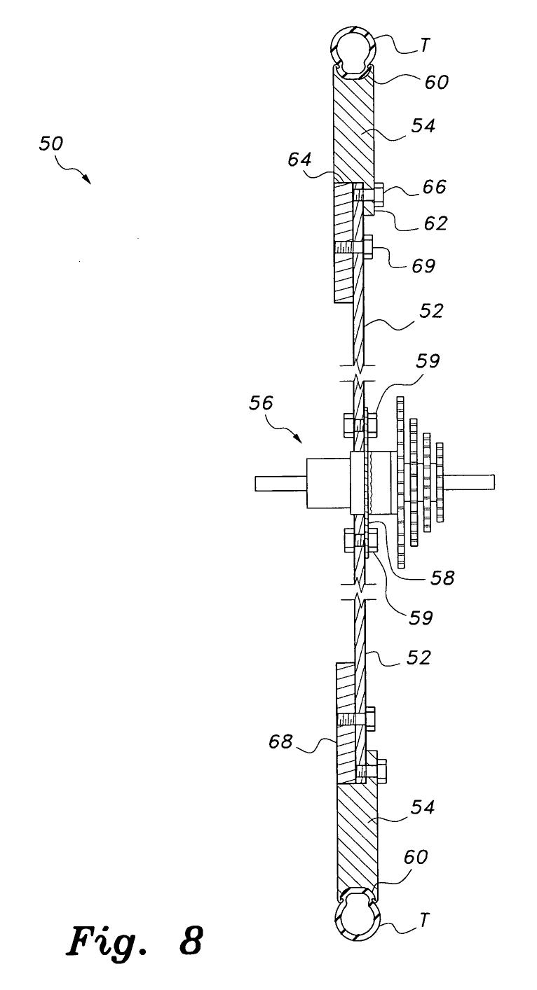

As shown in FIG. 6-8, the momentum booster 50 includes a relatively thin, circular wheel disc 52 and an annular weighted rim 54 mounted to the wheel disc 52. The wheel disc 52 is attached to the rear hub 56 of the bicycle by an intermediate annular ring, mounting bracket or mounting flange 58. The annular mounting flange 58 may be welded or formed on the hub 56 and includes a plurality of angularly spaced mounting holes through which fasteners 59 may be used to mount the hub 56 to the wheel disc 52 via corresponding mounting holes 57. The wheel disc 52 is preferably solid to support the additional weight of, and stresses from, the weighted rim 54, but optional holes 53 may be formed thereon to reduce the overall weight of the wheel disc 52. The holes 53 should be equidistantly spaced about the central axis of the wheel disc 52 to maintain overall balance of the rear wheel.

The annular weighted rim 54 is relatively thicker and has more mass than the wheel disc 52 in order to concentrate additional weight near the outer edge of the rear bicycle wheel and thereby maximize the momentum thereof for any given force acting on the rear bicycle wheel. Thus, a majority of the weight of the rear bicycle preferably rests in the weighted rim 54. Density of a given material has an effect on the weight of the annular weighted rim 54, so the dimensions of the rim 54 can be changed according to the desires of the user as long as the momentum boosting effect can be maintained, e.g., with a given desired momentum boosting effect, the width and length of the rim 54 can be relatively small if high density material is used or larger for a relatively lower density material. The weighted rim 54 helps to boost and maintain momentum in a similar manner as the outer disc 20. Due to the weight of the weighted rim 54, the rotation of rim 54, in response to pedaling, produces additional rotational momentum from inertia or a flywheel effect. This, in combination with the rotational momentum from the outer disc 20, ensures that momentum can be sustained for a longer period of time than by the outer disc 20 alone.

To mount the annular weighted rim 54, the rim 54 includes an inner stepped ledge 64 with an inwardly projecting extension or flange 62. The rim 54 also includes a drop well 60 on the outer, circumferential edge for mounting a bicycle tire T thereon. During assembly, the ledge 64 rests on the outer, circumferential edge of the wheel disc 52 while the projecting flange 62 rests on one side of the wheel disc 52. The projecting flange 62 includes a plurality of angularly spaced mounting holes where fasteners 66 may be used to securely mount the weighted rim 54 to the wheel disc 52. When assembled, the ledge 64 extends past the plane on the opposite side of the wheel disc 52 in order to distribute the weight and help balance the overall rear bicycle wheel.

If additional weight is required or desired, the wheel disc 52 includes a plurality of mounting holes 70 where additional weights 68 may be mounted. The mounting. holes 70 should be equidistantly spaced about the central axis of the rear bicycle wheel for balancing, and the holes 70 may be single holes, pairs or any other number as long as the additional weights 68 can be secured onto the wheel disc 52. Each additional weight 68 may be an annular or arcuate segment block of material with mounting holes corresponding to the holes 70. When assembled, the additional weights 68 are mounted to the wheel disc 52 on the side opposite the flange 62 with fasteners 69. In this manner, balance can be maintained. In addition, the arcuate, outer edge of the additional weight 68 abuts the extending portion of the ledge 64 so that the ledge 64 may be used as an installation guide for mounting the additional weight 68.

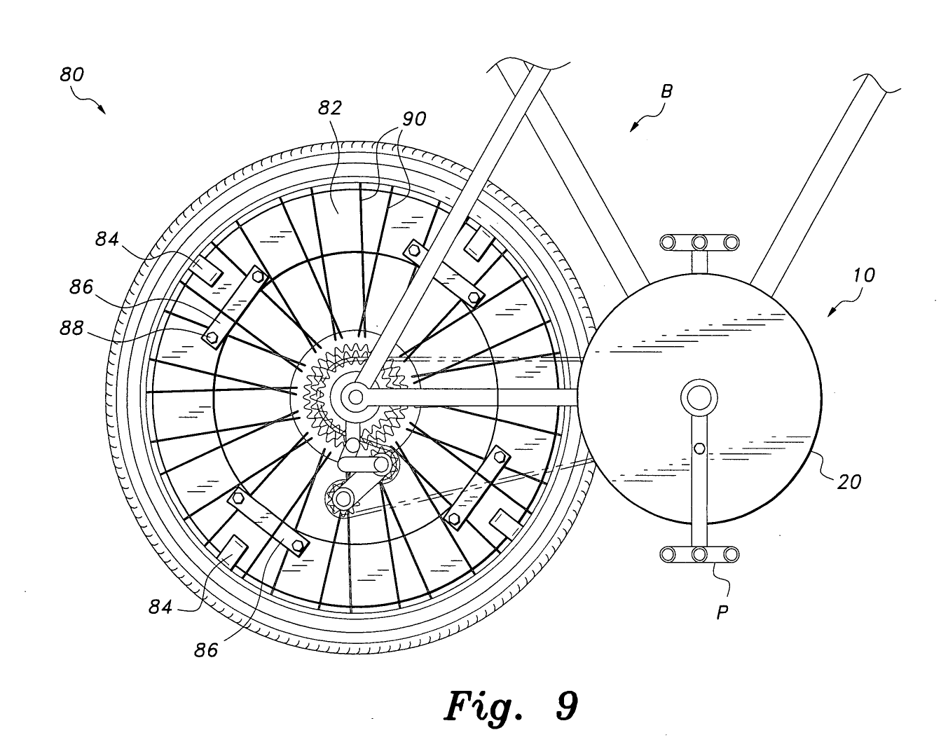

An alternative embodiment of a momentum booster 80 is shown in FIG. 9. In this embodiment, the alternative momentum booster 80 is configured for detachable mounting to the rear bicycle wheel, i.e., whenever needed. The momentum booster 80 includes a relatively flat, weighted ring or disc 82 mounted inside the rear bicycle wheel via equidistantly spaced holders 84. The holders 84 may be rectangular blocks that project a small distance past the circumferential edge of the weighted ring 82 so that the virtual diameter of the holders 84 are equal to or slightly greater than the inner diameter of the rear bicycle wheel. With this configuration, the holders 84 may be used to press fit the weighted ring 82 inside the rear bicycle wheel. However, the press fit may not be sufficient to keep the weighted ring 82 in place. To overcome this potentiality, the momentum booster 80 includes a plurality of holder straps 86 angularly spaced around the weighted ring 82. Each strap 86 straddles a pair of spokes 90 and secures the weighted ring 82 to the spokes 90 via fasteners 88. Thus, the weighted disc 82 is securely mounted to the rear bicycle wheel by press fit engagement of the holders 84 and by the holder straps 86.

The momentum booster 80 functions similarly to the momentum booster 50. The rotation of the weighted ring 82 during pedaling produces additional rotational momentum from inertia or a flywheel effect. This, in combination with the rotational momentum from the outer disc 20, ensures that momentum can be sustained for a longer period of time than by the outer disc 20 alone.

The bicycle pedaling system 10 may encompass a variety of alternatives. For example, the weight of the outer disc 20 may vary by material composition and density. The outer disc 20 may be relatively thin, with detachable weights mounted to the rims thereof. Moreover, the outer disc 20 may be fabricated to have varying density, low to high, in the radial direction. All the components of the bicycle pedaling system 10 including the momentum boosters 50 and 80 may be made from durable steel, plastic, wood or combination thereof. The spring-loaded pawl 46 may use any durable spring that maintains long lasting operative position of the pawl 46, or the pawl 46 itself may be made from a resilient material, i.e., the pawl 46 may be a leaf spring.

It is to be understood that the present invention is not limited to the embodiments described above, but encompasses any and all embodiments within the scope of the following claims.

I claim:

1. A bicycle chain drive sprocket wheel, comprising:
a weighted outer disc having a central bore defined therethrough, the outer disc having a sprocket-mounting side;
at least one bicycle chain sprocket mounted on the sprocket-mounting side of the outer disc;
a plurality of ratchet teeth projecting radially inward in the outer disc central bore;
an inner disc coaxially mounted in the central bore of the outer disc, the inner disc having a perimeter, the inner disc defining a bore adapted for receiving a spindle of a bicycle pedal crank arm journaled to the inner disc ii bore, the outer disc being rotatably mounted on the inner disc; and
a pawl projecting from the perimeter of the inner disc, the pawl engaging the ratchet teeth when the pedals rotate the crank arm and pivoting away from engagement with the ratchet teeth when the crank arm stops rotating in order to permit continued rotation of the outer disc when the inner disc has stopped rotation;
whereby the outer disc freely rotates about the inner disc to provide continuous momentum to ease subsequent resumption of pedaling effort.

2. The bicycle pedaling system according to claim 1, further comprising first and second caps mounted on opposite sides of said outer disc.

3. The bicycle pedaling system according to claim 2, further comprising first and second bearings disposed between said inner disc and said outer disc to provide a smooth rotational interface therebetween.

4. The bicycle pedaling system according to claim 3, wherein the outer disc central bore includes an inner, annular groove and said second cap has an inner surface, said inner disc comprising:
a cylindrical main body having a diameter and a circular flange integral with the main body at one end of the main body, the circular flange having a circumferential edge and a diameter greater than the diameter of the main body, the opposite end of the main body having an annular groove;
wherein the annular groove of said outer disc central bore and the circumferential edge of the circular flange together form a first race for said first bearings when assembled, and the inner surface of the second cap and the annular groove on the opposite end of the main body together form a second race for said second bearings, when assembled.

5. The bicycle pedaling system according to claim 1, wherein the sprocket-mounting side of said outer disc comprises a stepped axle having stepped seats for mounting said at least one chain sprocket thereon.

6. The bicycle pedaling system according to claim 1, further comprising a rear bicycle wheel having a momentum booster mounted thereon and a chain connecting said outer disc with the rear bicycle wheel, the momentum booster adding and sustaining continuous momentum during pedaling effort.

7. The bicycle pedaling system according to claim 6, wherein said momentum booster comprises:
a solid, thin circular wheel disc attached to a wheel hub, the wheel disc having a circumferential edge and opposite sides; and
an annular, weighted rim mounted to the circular wheel disc, the weighted rim having a circumferential edge.

8. The bicycle pedaling system according to claim 7, wherein said circular wheel disc has at least one hole defined therein to reduce the weight thereof.

9. The bicycle pedaling system according to claim 7, wherein said weighted rim comprises a drop well formed on said circumferential edge, said drop well for mounting a tire; an inner stepped ledge for resting on said circumferential edge of said wheel disc; and an inwardly projecting flange integral with said stepped ledge, said projecting flange having holes for mounting said weighted rim to said wheel disc.

10. The bicycle pedaling system according to claim 10, wherein said weighted rim has a weight greater than said wheel disc.

11. The bicycle pedaling system according to claim 7, further comprising at least one additional weight mounted to one of the opposing sides of said wheel disc.

12. The bicycle pedaling system according to claim 11, wherein said additional weight comprises an annular segment block.

13. The bicycle pedaling system according to claim 6, wherein said momentum booster comprises:
a flat weighted ring mountable inside the rear bicycle wheel, the weighted ring having a circumferential edge;
a plurality of holders extending radially inward from a rim of the rear bicycle wheel, the weighted ring being retained by the holders along the circumferential edge of the weighted ring; and
a plurality of straps fastening the weighted ring to adjacent pairs of spokes on the rear bicycle wheel.
